(19) United States
(12) Patent Application Publication
(10) Pub. No.: US 2022/0080848 A1
(43) Pub. Date: Mar. 17, 2022

(54) PORTABLE ALL-WEATHER ELECTRIC VEHICLE CHARGER AND INTERNAL COMBUSTION ENGINE STARTER AND BATTERY CONDITIONER

(71) Applicant: Omnitek Partners LLC, Ronkonkoma, NY (US)

(72) Inventor: Jahangir S. Rastegar, Stony Brook, NY (US)

(73) Assignee: Omnitek Partners LLC, Ronkonkoma, NY (US)

(21) Appl. No.: 17/475,125

(22) Filed: Sep. 14, 2021

Related U.S. Application Data
(60) Provisional application No. 63/078,222, filed on Sep. 14, 2020.

(51) Int. Cl. B60L 53/62; B60L 53/30; H02J 7/00; H02J 7/34; H01M 10/48; H01M 10/44; H01M 10/615

(52) U.S. Cl. CPC B60L 53/62; B60L 53/30; H02J 7/007194; H02J 7/342; H01M 2220/20; H01M 10/443; H01M 10/615; B60L 2240/54; H01M 10/486

(57) ABSTRACT

A portable battery charger for charging a vehicle battery in an electric vehicle including: a housing; one or more charger batteries; charging and conditioning electronics configured provide an input to heat a battery core of the vehicle battery and/or one or more charging batteries to above a predetermined temperature at which the vehicle battery is more efficiently charged; and a controller configured to: determine whether a temperature of the vehicle battery and/or the one or more charging batteries are less than the predetermined temperature; control the charging and conditioning electronics to input the vehicle battery and/or the one or more charging batteries with the input when the temperature is determined to be less than the predetermined temperature; and charge the vehicle battery using the one or more charging batteries when the temperature rises above the predetermined temperature.

### CROSS-REFERENCE TO RELATED APPLICATION

This application claims the benefit or earlier U.S. Provisional Application No. 63/078,222, filed on Sep. 14, 2020, the entire contents of which is incorporated herein by reference.

### BACKGROUND

### 1. Field

The present invention relates generally to portable rechargeable power sources that can be used to condition and/or charge the batteries of electric vehicles as well as be used to start or help to start vehicles with combustion engines in warm and in very cold temperature, and more particularly to novel portable power sources for emergency conditioning and/or charging of electric vehicle and internal combustion vehicle batteries at all ambient temperatures.

### 2. Prior Art

An EV is a vehicle that uses rechargeable batteries and an electric motor, which is driven by electric motor using energy stored in the batteries and charges the batteries using external power sources. Thus, like vehicles powered by internal combustion engines that require to refuel as the stored fuel is consumed by the engine, the batteries of EVs need to be recharged frequently as the level of stored electrical energy in the batteries drops as the vehicle is used. Therefore, charging stations must be provided for charging the EV batteries.

The number of electric vehicles is rapidly increasing. Like vehicles with internal combustion engines, an electric vehicle may run out of enough electrical energy to power the vehicle due to a driver distance and driving time miscalculation or getting stuck in unpredictable traffic and many other possible reasons. For vehicles with internal combustion engines, there are currently services that are provided for such emergency situations that would provide a relatively small volume of gasoline or diesel fuel to enable the vehicle to be driven 20-40 or so miles to a gas station for refill. Such a service, however, does not currently exist for electric vehicles (hereinafter referred to as “EVs”, which may be a small or full-size passenger car; a van or mini-vans; a motor cycles or tri-cycles; a SUV; a small or large truck; or almost any other electrically powered mobile platform such as a tractor or other farm or construction vehicle or snow blowing platforms and the like).

The only currently available method of addressing emergency electric vehicle out of power situations is to use an electric generator at the site to charge the EV battery to an acceptable level to allow the vehicle to be driven to a charging station. This method, however, does not work in low temperature environments since batteries such as Lithium-ion and Lithium-polymer batteries are damaged if charged at low temperatures, usually below zero degrees C.

The second option is to tow the EV to a charging station, which is usually not a preferable solution due to the cost and inconvenience of the entire process.

However, a portable rechargeable power source that can be used by emergency assistance services and are capable of conditioning and/or charging the batteries of electric vehicles at even exceptionally low temperatures at which the charging would damage the battery does not exist.

It is noted that hereinafter battery conditioning is intended to refer to the process of elevating the battery core temperature to a level at which the battery can be charged and/or be used to power an electric vehicle or start the internal combustion engine of a vehicle, such as a truck or heavy equipment and the like.

It is noted that most currently available charging methods and devices for rechargeable batteries, such as Lithium-ion or Lithium-polymer batteries most commonly used in electric vehicles, cannot be used to charge these batteries efficiently and without damage at low temperatures. For example, Lithium-ion or Lithium-polymer batteries should not be charged below zero degrees C. (32 degrees F.) since it damages the battery as a result of so-called lithium plating, which is essentially irreversible, prevents battery charging, and permanently damages the battery. Even at temperatures slightly above zero degrees C., the charging is significantly less efficient than it is at around room temperature.

However, recently developed technologies (see U.S. Pat. No. 10,063,076 issued on Aug. 28, 2018 and U.S. Pat. No. 10,855,085 issued on Dec. 1, 2020; U.S. Patent Application Publication Nos. 2020-0176998 filed on Jan. 22, 2019; 2020-0176835 filed on Jun. 24, 2019; 2020-0176999 filed on Sep. 30, 2019; 2020-0389033 filed on Jun. 20, 2020 and U.S. patent application Ser. No. 17/200,844 filed on Mar. 14, 2021; 17/200,846 file don Mar. 14, 2021 and Ser. No. 17/468,310 file don Sep. 7, 2021, the contents of each of which are incorporated herein by reference) provide the methods and apparatus for directly heating the battery electrolyte from external sources or from the battery power itself and keeps the battery temperature at the desired temperature for safe and efficient charging and discharge without damage to the batteries. It is therefore highly desirable that the portable rechargeable power source embodiments be provided with such battery core direct heating technologies so that the portable rechargeable power sources be capable of charging electric vehicle batteries at low (slightly above, below or at zero degrees C.) temperatures by first increasing their core temperature to a level at which they can be efficiently charged without damage and then proceed to their charging.

### SUMMARY OF THE INVENTION

There is therefore a need for methods to develop portable rechargeable power sources that can be used to condition and/or charge the batteries of electric vehicles at all temperatures, particularly at very low temperatures at which current electric vehicle batteries, such as Lithium-ion or Lithium-polymer batteries, cannot be charged efficiently and/or without damaging the batteries. Such portable rechargeable power sources are particularly needed for emergency conditioning and/or charging electric vehicles that have ran out of enough electrical power to operate the vehicle and get to a charging station.

There is therefore also a need for portable rechargeable power sources that can be used to condition and/or charge the batteries of electric vehicles at all temperatures, particularly very low temperatures at which current electric vehicle batteries, such as Lithium-ion or Lithium-polymer batteries, that cannot be charged efficiently and without damage to the batteries. Such portable rechargeable power sources are particularly needed for emergency conditioning and/or charging electric vehicles that have ran out of enough electrical power to operate the vehicle and get to a charging station.

The portable rechargeable power sources can be provided to emergency roadside assistance vehicles so that they could provide service to both electric vehicles when they are low on battery power to operate the vehicle and/or the batteries are at such low temperatures that could not provide enough power to operate the vehicle and at the same time they could respond to request for assistance to start vehicles with internal combustion engines by direct powering and/or by conditioning their (usually lead-acid batteries but also other rechargeable batteries) so that they could start their engines. The latter application may have greater applicability for heavy vehicles and equipment operating with heavy diesel engines in very cold temperatures.

The developed portable rechargeable power sources can also be configured to readily being adapted for conditioning/charging of almost all electric vehicles and conditioning all internal combustion engine batteries (usually lead-acid batteries) and/or starting most of their (generally smaller) engines, particularly for heavy equipment when they are required to operate at low temperatures.

The developed portable rechargeable power sources can also be configured to condition batteries of internal combustion engines, usually lead-acid batteries, in cold temperatures, usually below −10 degrees C., so that the batteries could start the engine. Such portable power sources can be used for conditioning of truck and heavy machinery diesel engines at exceptionally low temperatures.

The developed portable rechargeable power sources can be carried by emergency road-side assistant service vehicles to assist electric vehicles and vehicles with internal combustion engines with battery conditioning and/or charging service.

The developed portable rechargeable power sources can also be configured to keep their rechargeable battery cores at optimal temperatures at very cold temperatures so that they could perform at their peak performance levels.

The developed portable rechargeable power sources can also be configured to provide enough current at the required voltages to make them capable of rapid conditioning and rapid charging of electric vehicle batteries and to start various internal combustion engine and/or condition their batteries.

Accordingly, portable rechargeable power sources are provided that can be used to condition and/or charge the batteries of electric vehicles at all temperatures, particularly at very low temperatures at which current electric vehicle batteries, such as Lithium-ion or Lithium-polymer batteries, cannot be charged efficiently and/or without damaging the batteries.

Also provided are portable rechargeable power sources with integrated electrical and electronic control units that allow them to provide conditioning and/or charging service to almost all electric vehicles and conditioning service to almost all internal combustion engine batteries (usually lead-acid batteries), particularly for heavy equipment when they are required to operate at low temperatures, and/or starting service to most (generally smaller) internal combustion engines.

Also provided are portable rechargeable power sources configured to condition batteries of internal combustion engines, usually lead-acid batteries, in cold temperatures, usually below −10 degrees C., so that the batteries could start the engine. Such portable power sources can be used for conditioning of truck and heavy machinery diesel engines at exceptionally low temperatures.

Also provided are portable rechargeable power sources configured to keep their rechargeable battery cores at optimal temperatures at very cold temperatures so that they could perform their aforementioned battery conditioning and charging tasks at their peak performance levels.

Also provided are portable rechargeable power sources configured to provide enough current at the required voltages for rapid conditioning and/or rapid charging of electric vehicle batteries and to start various internal combustion engine and/or condition their batteries.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a schematic of an embodiment of an all-weather portable rechargeable power source for conditioning and/or charging of electric vehicle batteries and conditioning of internal combustion engine batteries at very cold temperatures and/or starting their engines.

FIG. 2 illustrates a schematic the all-weather portable rechargeable power source of FIG. 1 and a modular power extending battery pack and their connection to increase an amount of electrical energy that the power source can provide.

FIG. 3 illustrates an electrical schematic of the embodiment of FIG. 2.

### DETAILED DESCRIPTION OF THE PREFERRED EMBODIMENT

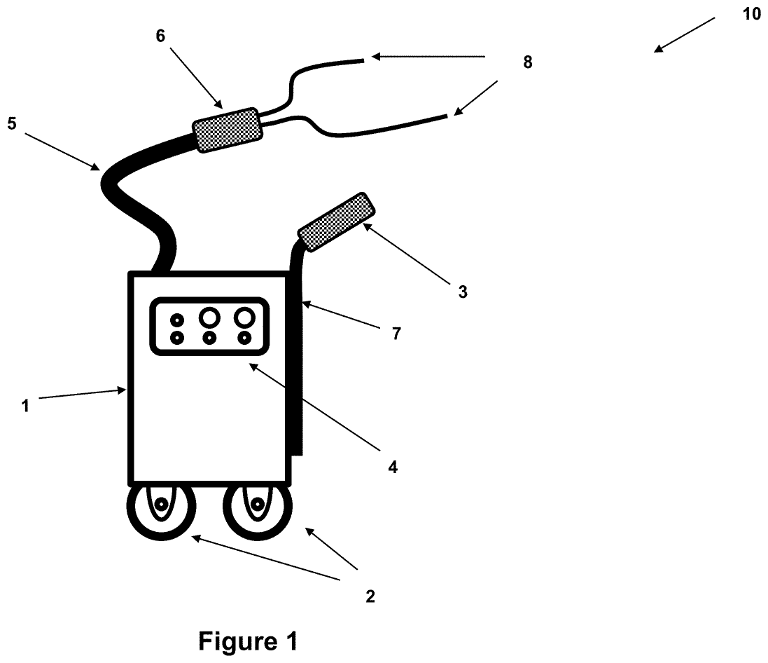

The schematic of an all-weather portable rechargeable power source for conditioning and/or charging of electric vehicle batteries or conditioning of internal combustion engine batteries at very cold temperatures and/or starting their engines is shown in FIG. 1 and is indicated generally by reference numeral 10.

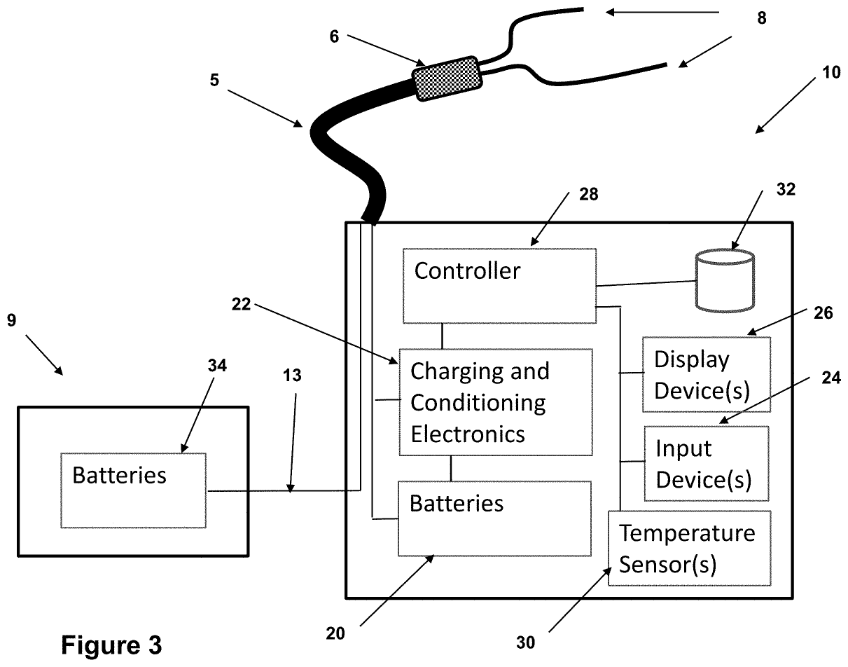

As shown in FIGS. 1 and 3, the all-weather portable rechargeable power source embodiment 10 is constructed with a housing 1, within which the power source rechargeable batteries 20 and their charging and conditioning electronics as well as the electrical and electronic circuits and components 22 for performing its functions as described later in this disclosure are considered to be assembled.

It is however appreciated by those skilled in the art that the high current electrical and electronic circuits used for battery conditioning and/or charging may be packaged in a separate housing to prevent overheating.

It is also appreciated by those skilled in the art that cooling fans may also be provided (not shown) in the housing 1 and be turned on automatically using a temperature sensor and control feedback loop to keep the rechargeable batteries and the power source electrical and electronic circuits from overheating during use.

It is also appreciated by those skilled in the art that with the currently available battery technologies, the most suitable rechargeable batteries for the power source embodiment 10 is generally either Lithium-ion or Lithium-polymer batteries. However, other batteries may also be used, particularly as lighter and higher density and cheaper batteries become available.

The all-weather portable rechargeable power source embodiment 10 is provided with wheels 2 and the handle 7 with the soft end portion 3 for the user to be able to move the unit to the desired positioning relative to the vehicle to be serviced. At least one panel 4, shown in FIG. 1 is provided on one side of the housing 1 (usually in front side, opposite to the handle 7), is used to mount all selection dials, switches (input devices 24), outlets, voltage and current indicating dials, which may be analog or represented on one or more displays 26, and the power source battery charging connections. A separate cable 5 may also be provided for higher current/voltage applications, such as for fast charging of electric vehicle batteries. The cable 5 may also be provided with an adapter 6, which can then be used to connect directly or via additional cables 8 to the intended load. It is appreciated that various combinations of outlets and output/input cables may be used in the all-weather portable rechargeable power source embodiment 10, depending on the user preferences and EV configuration, and what is illustrated in the schematic of FIG. 1 is an example of how they could be configured. In general, the need to weather-proof the device, particularly at the connector and outlet levels, must be considered for safety as well as for preventing damage to the power source, since the power source is expected to be used even under rain and snow conditions. Such weather-proofing is well-known in the art and accordingly is not discussed herein.

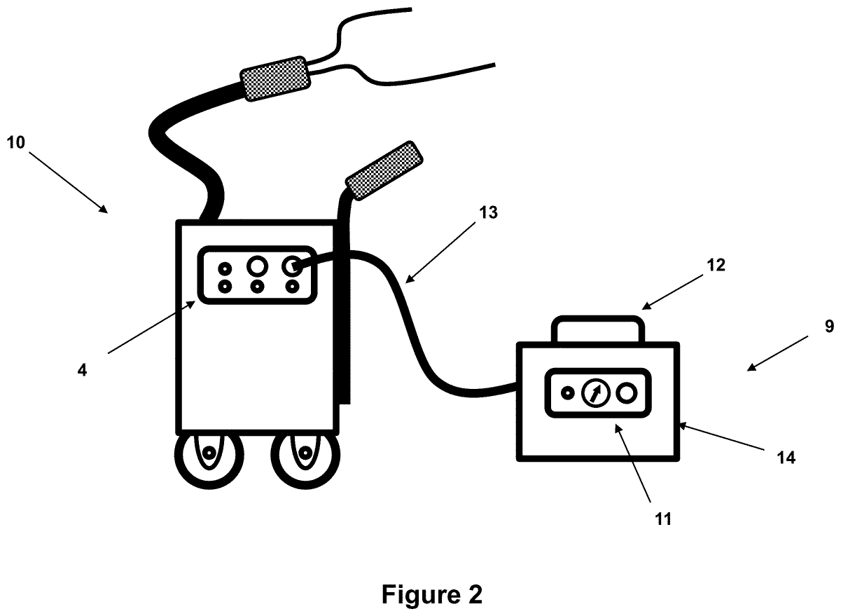

The all-weather portable rechargeable power source embodiment 10 is intended to be readily deployable from a service truck or a SUV type vehicle or any other type of vehicle hitch cargo carriers, etc. In general, the power sources are desired to weigh 30-50 lbs so that it is easily handled by most service vehicle personnel depending on the size of the rechargeable battery used in the power source since most of the required volume and weight of the power source unit is due to the size and weight of its battery pack. It is appreciated that larger size batteries are usually required for conditioning and charging of electric vehicles. However, since the disclosed all-weather portable rechargeable power sources are intended to be used for emergency charging of electric vehicles, they only generally need to be capable of charging passenger type electric vehicles for driving 20-25 miles to the next charging station and that should be achievable with a 30-50 lb power source unit. In addition, since service vehicles are expected to carry more than one power source unit or modular power extending battery pack units (FIG. 2), which are readily connected to the power source embodiment 10 to provide additional electrical energy, therefore the driving range of a passenger type electrical vehicle or the like can be readily extended even further by the providing service if needed.

As is common practice in the art, the batteries of the battery pack(s) of the all-weather portable rechargeable power source embodiment 10 of FIG. 1 may be provided with temperature sensors 30 and charge and temperature control electrical and electronic circuits (which may be integrated into the controller 28 and charging and conditioning electronics 22) to ensure safety and prevent damage to the batteries, such as over-heating, during charging and during discharge. In addition, when the power source batteries 20 are below safe charging temperature (below zero degrees C. for Lithium-ion and Lithium-polymer), then the electronic circuits constructed based on the aforementioned battery conditioning technologies are provided in the battery pack controller 28 to keep the battery core of the batteries 20 at the desired charging and discharging temperatures using external power if available or the battery pack 9 power directly.

The all-weather portable rechargeable power source embodiment 10 is intended to be used to perform its previously indicated functions as follows:

For charging electric vehicles: The powering cable 5 (directly through the adapter 6 or by attaching the vehicle specific cable 8 to the adapter 6) is connected to the charging port of the vehicle. Depending on the electric vehicle battery being charged, the input device(s) 24 on control panel 4 is/are set to the proper setting as described later in this disclosure, and the process of charging the electric vehicle battery is initiated. It is appreciated that the power source controller 28 would first measure the temperatures of the electric vehicle batteries using temperature sensors 30 and if they are below a desired temperature, usually below 5-10 degrees C., then the controller 28 would first activate the battery conditioning circuit 22 to heat the electric vehicle battery core and once the desired temperature has been reached, it would begin to charge the electric vehicle batteries. The controller 28 can be configured to continuously monitor the electric vehicle battery temperature during the charging process to ensure that they do not rise above a predetermined level. At very cold temperatures, the electric vehicle battery temperatures may drop below the set level during the charging process, in which case the controller 28 would stop the charging process and would raise the battery temperature as described above before resuming the charging process.

Conditioning batteries at cold temperatures: Currently, this service is usually required for increasing the temperature of lead-acid batteries of trucks and other heavy machinery in very cold temperatures high enough (usually to higher than −10 degrees C. but sometimes even higher than zero degrees C.) so that the battery 20 can provide enough current to start the engine. However, lead-acid batteries may be replaced in the future with lighter weight and higher energy Lithium-ion or Lithium-polymer or other similar batteries. In either case, the power source embodiment 10 of FIG. 1 is connected (preferably by clamps) to the battery terminals via the cable 5 and with the use of proper adaptor 6 directly or via another cable 8. If the EV batteries are not provided with temperature sensors, either cable can also be provided with an insulated temperature sensor 30 that is either integrated into the terminal clamping members or are directly clamped to the battery terminal to measure the approximate temperature of the battery core. The power source controller 28 is then set for conditioning (heating) the electric vehicle battery to the desired temperature, while allowing for the difference between the terminal temperature and the electric vehicle battery core temperature, where the terminal temperature is usually a few degrees lower than that of the electric vehicle battery core due to direct exposure to the external environment.

Starting an internal combustion engine: In this application, the power source is used as commonly available rechargeable power sources in which the battery output is set at the vehicle battery voltage and positive and negative outputs on the cable 5 are connected, for example by the commonly used spring loaded clamps, to the vehicle battery terminals and the vehicle ignition is activated to start the engine with the power that is provided mostly from the power source embodiment 10. It is also appreciated by those skilled in the art that the power extending battery pack 9 of FIG. 2 that is described below may also be used for this purpose, particularly for starting relatively smaller passenger cars or the like.

It is appreciated that in all above applications of the all-weather portable rechargeable power source embodiment 10, the power source controller can also be used to keep the power source batteries at their optimal temperature so that the power source could provide peak power to the vehicle battery being serviced. This is also the case for the modular power extending battery packs 9 described below.

FIG. 2 shows how the modular power extending battery packs 9 may be used to increase the amount of electrical energy that is available to an all-weather portable rechargeable power source embodiment 10 of FIG. 1. As indicated above, such power extending battery packs 9 may become needed only when charging electric vehicles when they are relatively far from charging stations. In most other applications, power extending battery packs 9 may not be needed.

As can be seen in the schematics of FIGS. 2 and 3, the power extending battery pack 9 has a housing 14, within which a rechargeable battery pack that can store the desired amount of electrical energy is assembled together with their required electrical and electronic charging and safety control electronics. The battery pack 9 can be provided with the electronic direct electrolyte heating component (not shown) that would keep the pack batteries at optimal temperatures for charging and for discharging as was previously described for the all-weather portable rechargeable power source embodiment 10 of FIG. 1. Thus, the battery pack 9 may be similarly configured as the all-weather portable rechargeable power source embodiment 10 as shown in FIG. 3. However, such battery pack 9 is connectable to the all-weather portable rechargeable power source embodiment 10, as shown schematically in FIG. 3. In FIG. 3, only the batteries 34 of the battery pack 9 is shown for simplicity and their connection to the all-weather portable rechargeable power source embodiment 10. As discussed above, the battery pack 9 may be configured with some or all the components as shown with regard to the all-weather portable rechargeable power source embodiment 10 in FIG. 3.

The power extending battery pack 9 housing 14 is provided with a handle 12 for ease of transportation. In general, the number and size of the batteries used in the power extending battery pack 9 is selected to make it possible for the pack to provide the desired voltage and current as described below, but also keep the size and particularly the weight of the pack low for ease of handling, preferably around 20-25 lbs.

The power extending battery pack 9 is provided with a panel 11 equipped with the required outlets and indicators for charging the battery pack and possible outlet from the battery pack for different uses as described below. The power extending battery pack 9 may also be provided with a power and data communication cable 13 for the proper terminal for connection to the power source 10 as shown in FIG. 2 to provide additional electrical energy to the power source when needed.

It is appreciated by those skilled in the art that by providing modular power extending battery pack 9 (with the option of providing varying amounts of electrical stored energy), the need for a heavy power source, FIG. 1, which may require assisting equipment for maneuvering it from the service vehicle to the intended vehicle sight is eliminated. In addition, the modular power extending battery pack 9, which are relatively lightweight and therefore portable and easy to handle, can be used to provide the required amount of electrical energy to the vehicle to be serviced.

It is also appreciated by those skilled in the art that the modular power extending battery packs 9, FIG. 2, may also be used, for example by the service vehicle personnel while going to the next service call, to charge the all-weather portable rechargeable power source embodiment 10 of FIG. 1.

It is also appreciated by those skilled in the art that in certain applications, such as when the power source embodiment 10 of FIG. 1 is used to start the engine of a heavy diesel engine, it should be able to provide current levels that are significantly higher than is possible to provide with current lightweight rechargeable batteries like Lithium-ion or Lithium-polymer batteries. In such cases, the power source embodiment may also be provided with a bank of super-capacitors that are connected in parallel and in series as is well known in the art to provide the required high current levels for the relatively short duration that is needed to stat the engine. For this reason, the control panel 4, FIG. 1, is also provided with the capability for the user to select the option of charging the super-capacitors and employing them (possibly together with the power source batteries) to start the intended engine.

In general, the controller 28 of the all-weather portable rechargeable power source embodiment 10 can use a microprocessor that is configured to perform the previously described functions of the power source. The user would then use the interactive input devices 24 and display device(s) 26 provided on the panel 4, FIG. 1, to select the desired function and enter the operational parameters related to the function, such as the electric vehicle type that is to be charged and the amount of electrical energy to be transferred to the vehicle batteries and other related information. The controller 28 is to be provided with a memory 32 having a database of all electric car battery characteristics and methods of charging. Similar database is can be provided for all other functions, such as the settings for voltage and current limits for conditioning lead-acid batteries. Alternatively, the controller can be configured to wirelessly access the database through a wireless data connection. Such database can also be provided in a separate housing and wired and wirelessly connected to the housing 1. The basic design of such microprocessor based controllers together with the required electrical and electronic switching and temperature controls are conditioning circuitry are described in the previously indicated conditioning patents incorporated herein by reference.

It is also appreciated by those skilled in the art that the above controller may also be packaged in a separate housing and be used with a power source similar to that of the embodiment 10 of FIG. 1, but without the described controller component.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A portable battery charger for charging a vehicle battery in an electric vehicle, the battery charger comprising:
a housing;
one or more charger batteries disposed in the housing;
charging and conditioning electronics configured provide an input to heat a battery core of one or more of the vehicle battery and the one or more charging batteries to above a predetermined temperature at which the vehicle battery is more efficiently charged; and
a controller configured to:
determine whether a temperature of the one or more of the vehicle battery and the one or more charging batteries are less than the predetermined temperature;
control the charging and conditioning electronics to input the one or more of the vehicle battery and the one or more charging batteries with the input when the temperature is determined to be less than the predetermined temperature; and
charge the vehicle battery using the one or more charger batteries when the temperature rises above the predetermined temperature.
